(19) United States
(12) Patent Application Publication
(10) Pub. No.: US 2007/0127793 A1
(43) Pub. Date: Jun. 7, 2007

(54) REAL-TIME INTERACTIVE DATA ANALYSIS MANAGEMENT TOOL

(76) Inventors: Bob L. Beckett, Waukesha, WI (US); Marcella A. Gonzalez, Waukesha, WI (US); Saad A. Sirohey, Pewaukee, WI (US); Tamanna N. Bembenek, Milwaukee, WI (US)

Correspondence Address: ZIOLKOWSKI PATENT SOLUTIONS GROUP, SC (GEMS), 136 S WISCONSIN ST, PORT WASHINGTON, WI, 53074, US

(21) Appl. No.: 11/276,709

(22) Filed: Mar. 10, 2006

Related U.S. Application Data
(60) Provisional application No. 60/739,561, filed on Nov. 23, 2005.

(51) Int. Cl. G06K 9/00

(52) U.S. Cl. 382/128

(57) ABSTRACT

Images and quantitative analytical data are displayed in an interactive manner to a user to facilitate efficient and effective diagnosis, treatment, and assessment of an abnormality or pathology. Images acquired over time, which may be acquired with scanners of various modalities, are registered, displayed in a single image, and comparatively quantified to provide historical analysis of a given abnormality or pathology. The historical images and quantitative data may then be analyzed to determine the effectiveness of an applied treatment and provide additional guidance for a to-be implemented treatment. The images may include anatomical images or functional images. The quantitative data may be displayed in an interactive tabular format or displayed graphically through histograms, charts, graphs, and the like.

### CROSS-REFERENCE TO RELATED APPLICATION

The present invention claims the benefit of U.S. Patent Application Ser. No. 60/739,561, filed Nov. 23, 2005.

### BACKGROUND OF THE INVENTION

The present invention relates generally to medical diagnostics and treatments assessment and, more particularly, to a medical diagnostic and assessment tool simultaneously and interactively displaying anatomical and functional information for a plurality of patient medical exams. The anatomical and functional information includes image and quantitative data acquired from a patient over a period of time and aids a physician in establishing treatment for a particular abnormality or pathology and assessing the effectiveness of that treatment.

It is not uncommon for a single patient to undergo a multitude of imaging exams, whether in a single doctor's visit, in a hospital stay, or even over the course of a lifetime. This is particularly likely when a patient undergoes a series of “tests” and scans to investigate a recently onset or previously undetected condition, such as cancer or dementia. It is increasingly common for a patient to be subjected to multiple scans across multiple modalities because each exam can provide different pieces of information. For example, during a single doctor's visit or hospital stay, magnetic resonance imaging (MRI), x-ray, or computed tomography (CT) can be used to acquire images that provide anatomical information, while positron emission tomography (PET) or functional MRI can be used to acquire images that provide functional information. The anatomical information providing insight into the anatomical makeup of the patient and the functional information providing insight into the functionality of a given anatomical structure, especially when subjected to a stimulus. Moreover, the combination of anatomical and functional information is not only advantageous in detecting a new pathology or abnormality, but the respective images, when taken over the course of an illness, for example, may show growth of lesions, responses to treatments, and disease progression. To assist in the analysis of anatomical and functional information, programs have been constructed that register an anatomical and a functional image thereby showing, in a single image, both anatomical and functional information.

Many clinical applications analyze 2D or 3D image data to perform and capture quantitative analytics. These include detection and sizing of lung nodules (Advanced Lung Analysis), quantification of vessel curvature, diameter and tone (Advanced Vessel Analysis), cardiac vascular and function applications, navigation of the colon for detection of polyps (CT colonography), and the like. In addition, there are neurological disorders that are analyzed using comparison with normal cohorts and creation of deviation maps. Dedicated CT, MR, PET and nuclear medicine applications have been designed to output quantitative analytics from regions of interest (intensity, density (HU), specific uptake volume (SUV), distances, volumes, growth rates, pattern and/or texture recognition, functional information, etc.) to help in the diagnosis and management of patients. However, physicians lack tools to interact with quantitative data analysis for diagnosis and patient management. That is, quantitative information may be ascertainable in charts, etc., but the information is not readily accessible together with the corresponding images to the physician. As a result, the physician must reconcile the results of several tests, both in the images themselves and the resulting quantitative data, in a crude and predominantly manual manner. For example, physicians typically rely on the apparent anatomical size and shape of patient cancerous lesions when assessing response to a chosen treatment or therapy. However, functionality to measure, archive, and manage analytic data over time is limited.

It would therefore be desirable to have a system and method capable of displaying analytical data and the corresponding images from which the analytical data was captured to a physician to quantify response of a disease or lesion to treatment over time in an interactive manner.

### BRIEF DESCRIPTION OF THE INVENTION

The present invention provides a system and method of displaying analytical data and medical images interactively that overcomes the aforementioned drawbacks.

A real-time interactive data analysis management and review tool for managing disease and/or pathology response to treatment or therapy is presented. The invention involves the archival of quantitative analytics data for the purpose of immediate or long term retrieval for comparative review over time and the display of current quantitative analytic data in a usable format that offers quick comparisons to previous quantitative analytic data for informed patient management. The usable format may be displayed in tabular or graphical layouts. The tool can be incorporated in the clinician reading workflow to be positioned between analysis image review and structured patient reporting. Positioning in this manner will allow direct interaction between these two important reading workflow processes. By selecting and clicking on a localizer image, the tool will automatically hotlink to analysis review and display the image of interest in a primary focused viewport. Conversely, the physician will be able to propagate to the patient report one or more graphs or analytical data deemed related for report archival. The invention also includes an electronic datasheet for posting relevant measurements in a spreadsheet format specific to an application. In the PET/CT application example, SUV max, Functional Volume, Anatomical Volume, SUV Mean, % Volume Change, etc. are examples of measurements that are displayed. The datasheet allows the user to select any lesion of interest and hotlink to the book-marked image displayed in the analysis viewports for further visual analysis. The invention leverages graphical charts to show disease or lesion response to treatment. The invention also includes an interactive navigational interface that allows the user to quickly select chart, tables, and other quantitative data of interest. Localizer or thumbnail images can be selected and hotlink to the analysis review for a more detailed visual analysis of that specific disease or lesion. A thumbnail image reference is used for hotlinking to analysis or simply for a visual reference.

The invention further provides interactive data analysis between analysis image review and patient structured reporting. Thus, the invention is interactive with both these components of reading workflow. The invention also facilitates management of quantitative analytics associated with disease and lesion progression as well as disease and lesion response to medical or therapeutic treatment.

The invention is applicable to a number of physiological studies including oncology and neurology related pathologies. Current methods produce analytics from PET/SPECT images that show functional deviations in metabolic or perfusion rates from a normal cohort. These deviations are either displayed point-wise or ROI/VOI based on regions of a standardized brain, i.e., individual brain mapped to a standard atlas. In addition to PET this functional information can also be determined using fMRI. Neurological diseases, particularly dementia, i.e. Alzheimer's disease, also have anatomical markers as their indicators. These include atrophied regions in the brain, i.e. reduction of the hippocampus, as well as other changes to the brain anatomical regions that can be imaged using CT and/or MR and quantified using analysis tools. A similar transformation to the standardized space will allow for anatomical and functional information to be co-registered. With the invention, data analysis methodology allows for the anatomically relevant regions to be analyzed simultaneously using anatomical and functional attributes. Likewise, longitudinal studies can also be merged to allow for diagnosis, characterization of therapy response and/or treatment planning. This invention provides productivity tools for the streamlined data analysis of disparate information.

Therefore, in accordance with one aspect of the present invention, a computer-readable storage medium having a computer program stored thereon and representing a set of instructions is disclosed. The computer program when executed by the computer causes the computer to access a first set of data of a first data type and a second set of data of a second data type. The first set of data and the second set of data are acquired from an object of interest, and the first set of data is acquired in a first plurality of scans and the second set of data is acquired in a second, different from the first, plurality of scans. The set of instructions further causes the computer to display a change in the value of the quantitative metric between the first plurality and the second plurality of scans.

In accordance with another aspect, the invention includes a medical diagnostic tool having an image database configured to contain medical images of a patient acquired over a period of a time as well as an analytical data database configured to contain analytical data related to the medical images. A graphical user interface interactively displays the medical images from at least a pair of medical exams together with the analytical data related thereto, and allows real-time data analysis and review of changes in the medical images acquired over the period of time.

According to another aspect of the invention, a method of presenting medical information is provided. A history of patient medical imaging exams is acquired. At least one of quantitative anatomical data and quantitative functional data from the history of patient medical imaging exams is then accessed. At least one of the quantitative anatomical data and the quantitative functional data for at least two patient medical exams of the history of patient medical exams is displayed together with at least one fused image from the history of patient medical imaging exams to allow interactive assessment of time-elapsed changes of a patient. The fused image contains anatomical and functional information.

Various other features and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 illustrates an interactive data management and analysis tool according to one aspect of the invention.

FIG. 2 illustrates an exemplary analytical quantitative data window in accordance with one aspect of the present invention.

FIG. 3 illustrates an exemplary embodiment of the interactive data management and analysis tool of FIG. 1 following a user input to the analytical quantitative data window thereof in accordance with the present invention.

FIG. 4 shows the interactive data management and analysis tool of FIG. 1 following a user input thereto in accordance with another aspect of the invention.

FIG. 5 illustrates the interactive data management and analysis tool according to an exemplary embodiment of the invention with a superimposed pop-up window in accordance with another aspect of the invention.

FIG. 6 illustrates another exemplary embodiment of the present invention with a superimposed pop-up window containing graphically displayed comparative analysis in accordance with a further aspect of the present invention.

FIG. 7 illustrates another exemplary pop-up window that may be superimposed on the interactive data management and analysis tool in response to a user input according to another aspect of the invention.

FIG. 8 is a flowchart setting forth the steps of a process for displaying medical imaging quantitative data in accordance with yet another aspect of the invention.

FIG. 9 illustrates yet another aspect of the present invention whereby a user may compare the results of multiple exams in a single graphical user interface.

FIG. 10 illustrates displaying of another exemplary comparative analysis similar to that shown in FIG. 9 according to a further aspect of the invention.

FIG. 11 is a schematic of an exemplary imaging machine for use with the present invention.

The drawings include exemplary graphical windows, graphical tables, graphical charts, and the like, flow charts and process maps illustrating various aspects of the invention.

### DETAILED DESCRIPTION OF THE PREFERRED EMBODIMENT

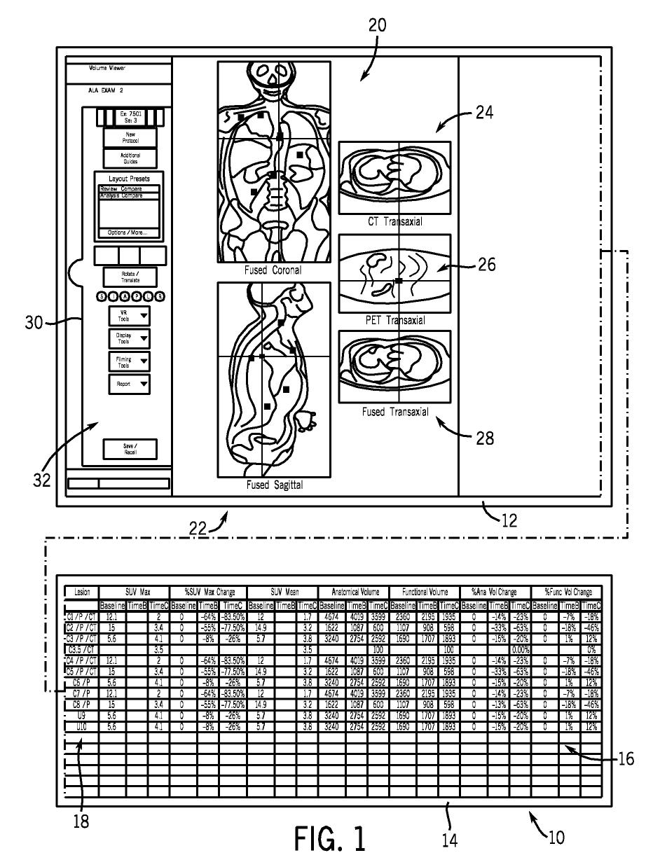

Referring now to FIG. 1, an interactive data management and analysis tool according to one aspect of the invention is illustrated. The interactive tool includes a graphical user interface (GUI) 10 that displays a pair of widows 12, 14. One window 12 is used to display images, and the other window 14 is used to display quantitative data in either tabular or graphical format. In one preferred embodiment, two computer displays, CRTs, monitors, etc. are used to display the pair of windows 12, 14. As will be described, the images window 12 is generally a static window and the data window 14 is dynamic. That is, a user input to the dynamic window 14 causes a change in the display of the images window 12. Thus, user interaction is preferably only with the data window 14 when managing and analyzing the quantitative and corresponding image data. However, it is contemplated that both windows 12, 14 may be dynamic in nature and each be responsive to user inputs.

The data window 14, which displays quantitative analytical data 16 captured from a history of medical exams stored in a database (not shown) or other image archive, enables a user to identify and select a listed pathology or abnormality 18 which automatically causes an image of the selected pathology or abnormality be recalled from an image database (not shown) and to appear in the images window, as will be described later. In one embodiment, the resulting images are displayed with segmentation so that the portion of the total image acquired from the patient corresponding to the selected abnormality or pathology is only displayed. Moreover, the interactive nature of the quantitative data allows the user to select and display anatomical, functional, or registered images in the images window.

In FIG. 1, the image window 12 shows multiple images further illustrating the robustness of the data analysis tool. Specifically, a fused coronal image 20 and a fused sagittal image 22 are displayed. Images 20, 22 are captured from an entire region of interest of the subject and are the fused images, each from different imaging planes, of respective images acquired from various scanners of differing modalities. That is, in the illustrated example, the fused images are formed from registering a CT image with a PET image. Also shown in the images window is a transaxial CT image 24, a transaxial PET image 26, and the resulting fused transaxial image 28. By registering and fusing the respective images, anatomical and functional information acquired with different scanners and, possibly, scanners of different types, can be displayed in a single image for further inspection and analysis by a physician.

In the example shown in FIG. 1, the GUI 10 further includes a navigational pane 30 that includes several interactive windows 32 to enable the clinician to interact with the data to select images to be displayed, rotate images, select a particular exam, save data, and the like.

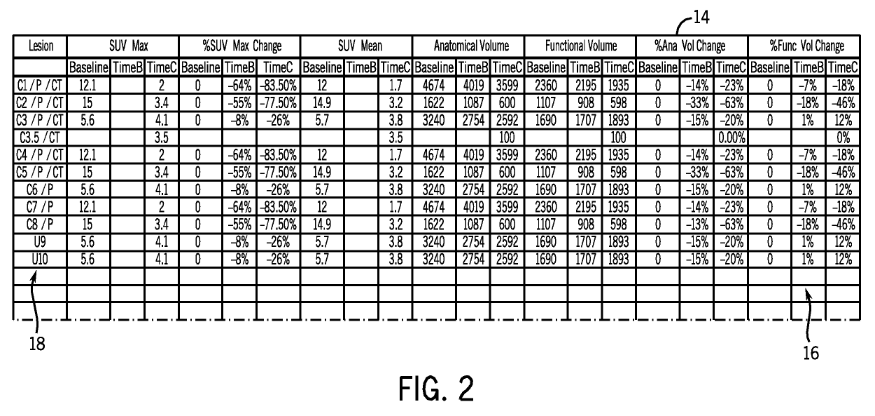

Referring now to FIG. 2, exemplary analytical quantitative data window 14 in accordance with one aspect of the present invention is shown. In this example, the quantitative data is arranged in a tabular format of columns and rows to segment data for various abnormalities and pathologies and, in particular, as a function of certain measured parameters. In this example, which is tailored to an oncology study, each row corresponds to measured values for a given lesion of list 18. The lesions may be computer identified or physician identified. The lesion identifiers provide an indication as to the manner in which the lesion was identified. For example, lesion “C1/P/CT” indicates that the first listed lesion was detected automatically by a computer based on acquired PET and CT images. On the other hand, lesion “C6/P” indicates that the computer identified the lesion based on a PET image alone. Lesion “U10” indicates that the lesion was identified by the physician. It is understood that other naming conventions may be used to identify particular abnormalities and pathologies. It is also contemplated that all identified abnormalities and pathologies may be computer detected or physician detected. The automatic detection of lesions as well as user-selection of lesions in an image is well-known.

Each column in the tabular arrangement of corresponds to a different measured or computed parameter. In the illustrated example, the measured parameters include SUV max, SUV mean, Anatomical Volume, and Functional Volume. The quantitative data also includes computed values and those columns include % SUV Max Change, % Anatomical Volume Change, and % Functional Volume Change. It is understood that these measured and computed parameters are exemplary and that other or additional parameters may be used depending on the particulars of the imaging study and/or the medical condition under investigation. It is also contemplated that the parameters may be arranged in menus and, through a user-input, different menus can be displayed in window 14. In this regard, it is contemplated that fewer than all the parameters for a given study may be displayed at a time and the user can navigate through the menus in a conventional manner.

As also illustrated in FIG. 2, under each column heading, there are multiple values for each identified lesion. The multiple values correspond to data derived from multiple exams. Thus, in the illustrated example, a baseline value is identified for each of the measured parameters. This baseline value corresponds to the value for the measured parameter when the lesion was first diagnosed or discovered. This baseline value will be used for comparative analysis of quantitative data derived from subsequent medical exams taken at different periods of time. Thus, the data for time B and time C correspond to data derived for the measured parameter in subsequent scans. This provides a single user interface to provide historical comparative analysis to the physician. Moreover, as the quantitative data includes comparative parameters, measured values are compared resulting in the display of a comparative value, such as % SUV Max Change. In the illustrated example, all the comparative values are relative to the initial baseline value. That is, for the Time C comparative values, the value for the measured parameter for exam conducted at Time C is compared to the value measured during the baseline exam. However, it is contemplated that the comparative values for the exam conducted at Time C could be compared to the values for the exam conducted at Time B. Additionally, it is contemplated that the physician may select of which exams the results are to be compared based on inputs to navigational pane 30, FIG. 1. That is, it is contemplated that quantitative data for fewer than all the medical exams taken of the patient may be displayed in data window 14; however, to provide a complete historical evaluation and assessment, it is preferred that the data from all medical exams be displayed in a chronologically-oriented manner.

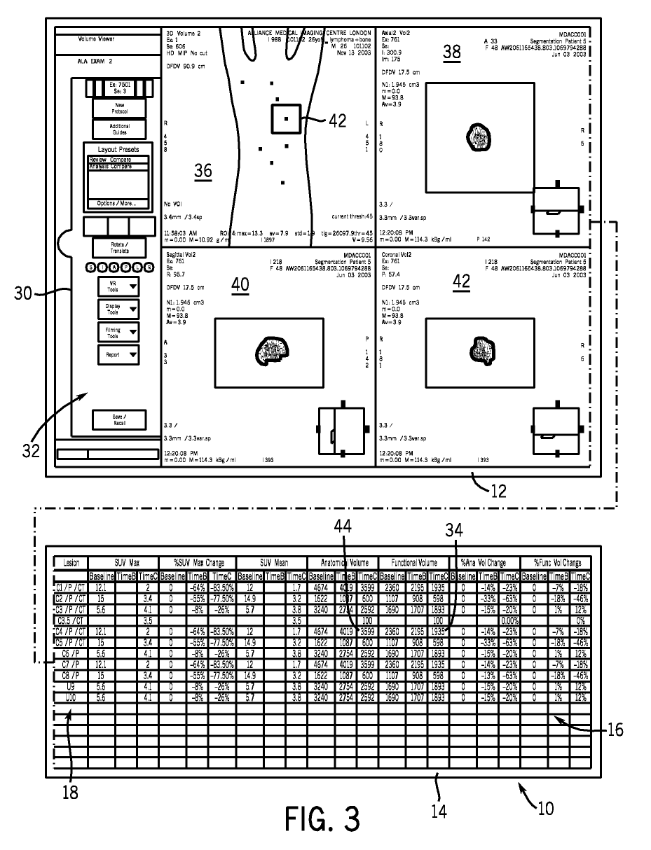

As described above, the data analysis tool 10 is interactive. In this regard, the tool allows a physician to interact with the quantitative data and the images to fully assess and treat a given patient. For example, referring to FIG. 3, a user selection at the highlighted value 34 causes the images that were used to determine the value corresponding to that lesion for the corresponding measured parameter to be displayed in images window 12. In the illustrated example, selection of cell 34 automatically causes four images 36, 38, 40, 42 to be displayed in the images window 12. In the illustrated example, image 36 corresponds to a complete region of interest image with the selected lesion identified in target or localizer box 42. Images 38, 40, 42 correspond to the various registered images used to determine the value at cell 34. In the example, the images correspond to an axial image 38, a sagittal image 40, and a coronal image 42. Moreover, as the selected value corresponds to a measurement of functional volume for the medical exam at Time C, the images are functional images from the Time C medical exam. Moreover, the images 38, 40, 42 are only of the lesion selected and, thus, the lesion images have been segmented from the global image 36.

As reference above, images 36, 38, 40, and 42 are functional images that are displayed because the physician selected a functional parameter on data window 14. In this regard, if the physician had selected cell 44, the images window would have been automatically updated to display anatomical images from the medical exam conducted at Time C for the same lesion. Thus, through inputs to the quantitative data window 14, the physician can interactively view and analyze the several images acquired from a patient acquired in several medical exams over an extended period of time. This advantageously allows a physician to not only detect abnormalities and pathologies but also assess the effectiveness of treatment of the abnormalities and pathologies.

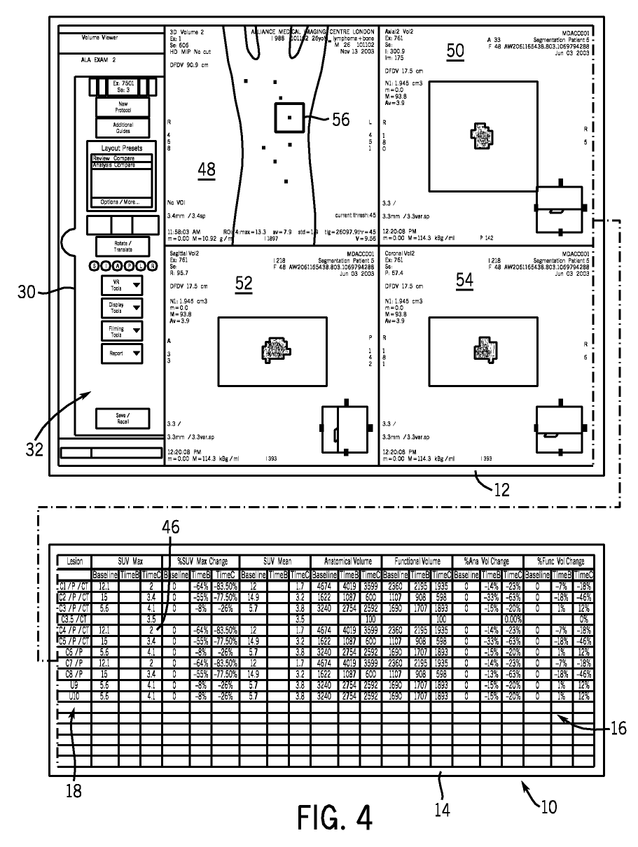

Referring now to FIG. 4, the analysis tool 10 is shown after user selection of cell 46. Selection of this cell results in the automatic display of the images used to determine the value corresponding to the selected parameter, which, in the illustrated example, corresponds to SUV Max for the exam taken at Time C for lesion C4/P/CT. The displayed images 48, 50, 52, 54 correspond to a global image 46 and a series of localized images 50, 52, 54. Localizer box 56 of image 48 corresponds to the region of the global image 48 comprising lesion C4/P/CT. Images 50, 52, 54 correspond to axial, sagittal, and coronal images, respectively, and visually display to the physician the images that were used to provide the value of “2” for SUV Max for lesion C4/P/CT at tab position 46 in the data window 16. Thus, the interactive tool provides the resulting quantitative data and interactively automatically displays the images that were used to derive the corresponding quantitative data.

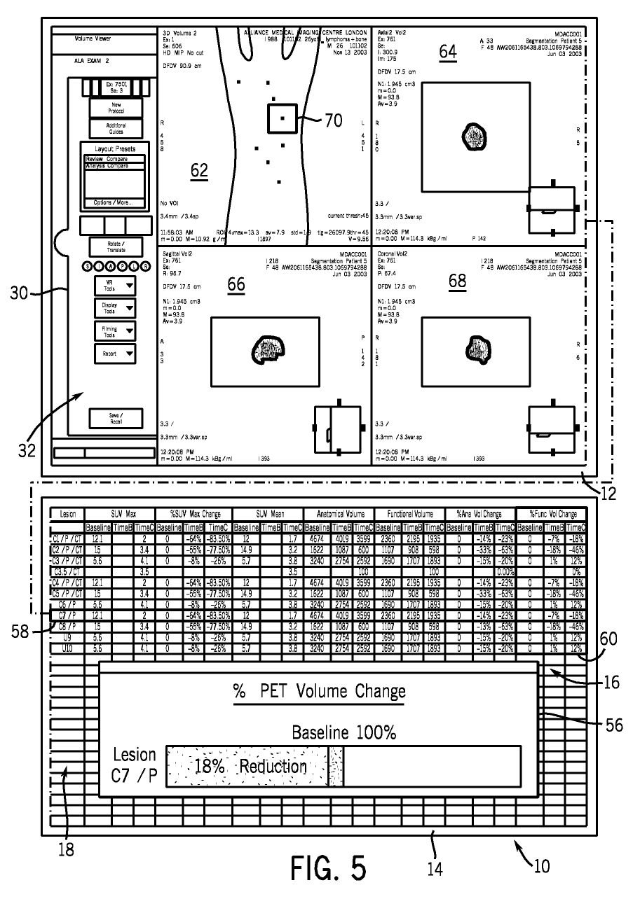

Additional functionality of the interactive data analysis and management tool 10 is illustrated in FIG. 5. As shown therein, a physician may cause a graphical display of a measured parameter through one or more user inputs directly to the data window 14. In the illustrated example, pop-up window 56 is displayed in response to user selection of lesion C7/P identifier 58 followed by user selection of % Func Vol Change column header 60. As a result of these two inputs, a graphical representation of the measured value for % PET Volume Change is shown in window 56. In the illustrated example, the measured values used to derive the graphical representation in window 56 are derived from data derived in a baseline exam and data derived from an exam taken at Time C. In one preferred embodiment, any comparative graphical representations are, by default, based on a comparison derived from the most recent exam as compared to data derived from a baseline exam. It is contemplated, however, that through one or more user selections, the graphical representation may be made between any two, three, four, etc. exams.

Still referring to FIG. 5, the images 62, 64, 66, 68 are displayed in the images window 12 in a manner similar to that described above. In this example, localizer box 70 identifies the location of the selected lesion at input 58 on the global image 62. Images 64, 66, 68 correspond to an axial, sagittal, and coronal images, respectively, of the lesion. Because the physician selected a functional information parameter 60, e.g., % Func Vol Change, the images are functional images and correspond to the images used to derive the functional volume values of the corresponding images of the exam taken at Time C.

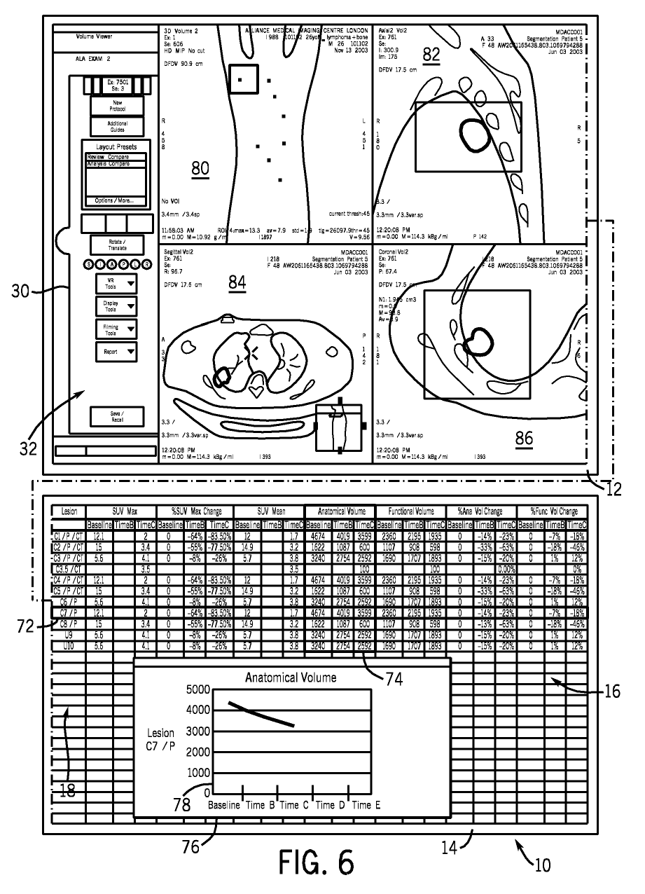

Similarly, as shown in FIG. 6, selection of a given lesion identifier 72 and an anatomical parameter header identifier 74 causes the display of a pop-up window 76, which, in the example, corresponds to anatomical volume. As shown, the graphical display includes a histogram 78, but could also be other graphical tools to readily display comparative information. In this example, the histogram displays anatomical volume of lesion C7/P over time as measured in exams taken at baseline, Time B, and Time C. The corresponding global image 80 and localizer images 82, 84, 86 are displayed in the images window 12, in a manner similar to that described above.

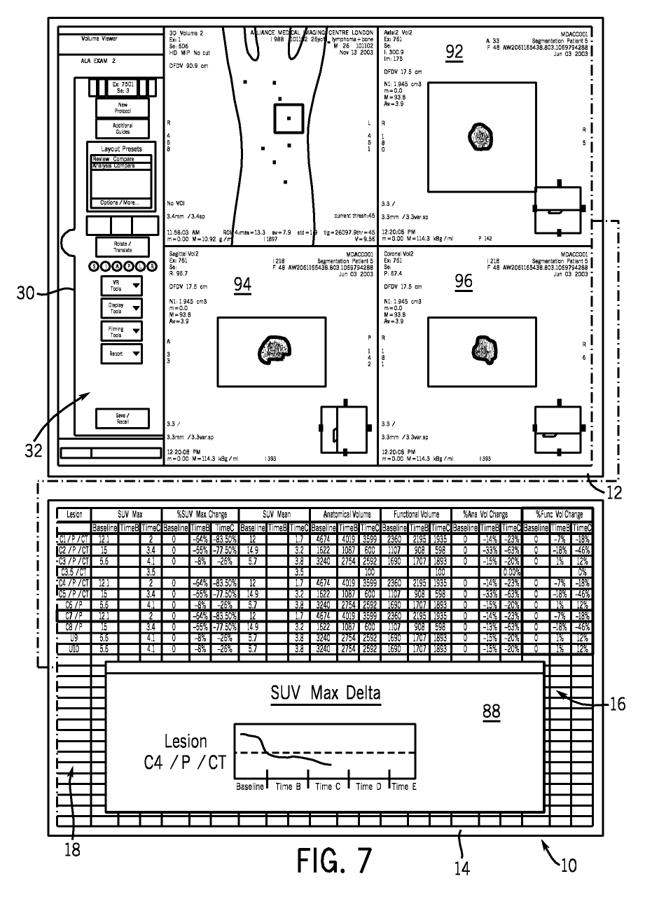

FIG. 7 illustrates another pop-up window 88 that may be displayed in response to one or more user inputs to the quantitative data window 14. Window 88 appears as a result of user inputs similar to those described above. In this example, the pop-up window 88 shows SUV Max Change for lesion C4/P/CT in a histogram for exams taken at baseline, Time B, and Time C. The images in images window 12 correspond to the global image 90 and a series of localized images 92, 94, 96 that are taken along the axial, sagittal, and coronal planes, respectively.

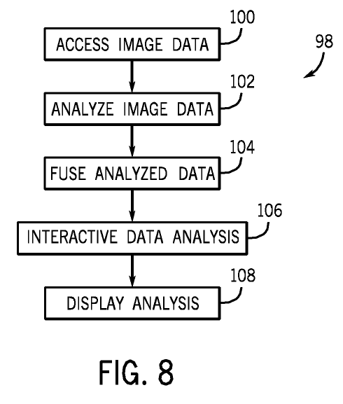

FIG. 8 illustrates a process map according to the present invention. The process 98 begins with the accessing of image data 100 from a local or remote database, such as a picture archival and cataloguing system. The image data is acquired from multiple exams conducted at different periods of time. The image data may be single modality data or multi-modality data. In a networked scanner environment, the images may be acquired at different scan locales.

The image data is then analyzed at 102 to determine quantitative data corresponding to the images. Exams may be analyzed independently or in the context of other exams, e.g., auto-segmentation of PET data from a CT scan. The analysis may be performed manually, semi-automatically, or fully automatically. It is during this analysis stage that lesions are identified in the various images, either automatically or manually.

The analyzed data is then fused together at 104. For example, in a PET/CT scan, two exams are registered. For a given organ, both anatomical and functional information are displayed together. This includes showing a fused image and reporting information corresponding thereto. In another example, two chest x-rays exams taken at different times are registered. For a given nodule, an image may be displayed that shows the differences in nodule size between the two exams. In a neurology example, images from two MR exams taken at different times on a patient stricken with Alzheimer's disease may be fused together with disease progression over time shown in the registered image. In this regard, analysis may be in the form of images, fused images or measurements (depicted graphically or in text). The analytical results may be acquired from images of a single exam, multiple exams, or a combination of exams.

After the quantitative analysis has been derived, the windows of interactive data analysis tool described above are populated 106 to allow a physician to interactively review and assess the medical exams of the patient. As described above, the interactive tool, which may be graphically and/or textually displayed, enables a physician to effectively and efficiently assess a given abnormality or pathology and determine the effectiveness of treatment. As shown above, the quantitative data and corresponding images are displayed in an interactive and organized format and alleviates the need to discern multiple image documents and patient charts simultaneously.

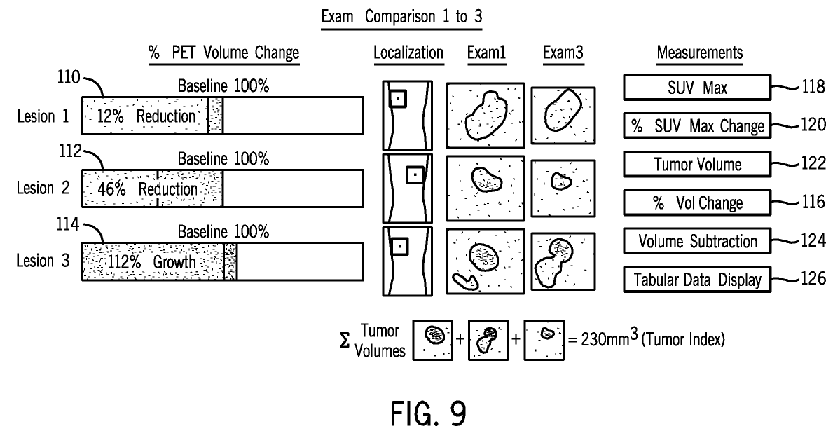

As described above, through textual and graphical displays, analysis of data can be displayed at 108 in both an informative and comparative manner. Thus, the physician can navigate interactively with images and data derived from those images acquired of the patient over an extended period of time. Moreover, as shown in FIG. 9, the physician may compare the results of multiple exams in an efficient manner.

As shown in FIG. 9, comparison between a first exam and a third exam are graphically displayed. In illustrated example, % PET Volume Change for three different lesions 110, 112, 114 are shown relative to another as a result of use selection of “% Vol Change” tab 116. Other comparative analysis and results may be created by depressing any of the other selector tabs 118, 120, 122, or 124. Showing the results in a tabular format rather than graphically can be done by toggling tab 126.

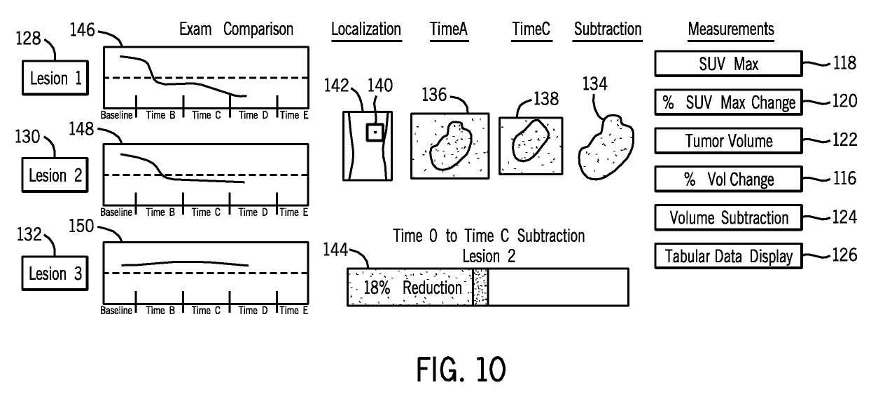

A similar comparative analysis is shown in FIG. 10. Illustrated therein is volume subtraction for three lesions 128, 130, 132 between an exam at Time A and an exam at Time B. The resulting subtraction image 134 for lesion 2 is also displayed. Image 134 is derived from lesion localizer images 136, 138 which correspond to localizer section 140 of global image 142. A graphical chart 144 provides a visual value of the subtraction between the localizer images that is captured in the subtraction image 134. An exam comparison, through historical plots 146, 148, 150, is also displayed for each of the three exemplary lesions for all time periods.

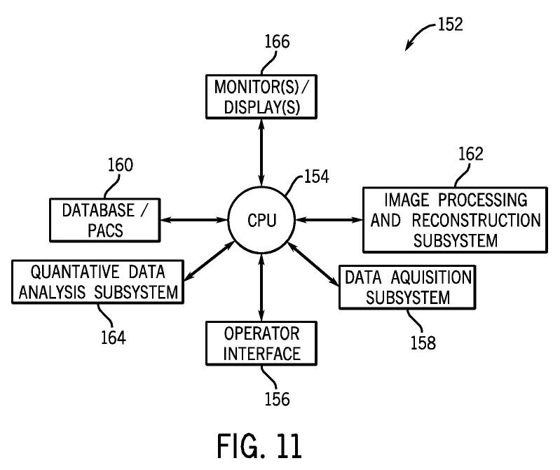

Referring now to FIG. 11, an exemplary imaging system for use with the present invention is shown. The imaging system is not modality specific. In this regard, the system 152 includes a central processor (CPU) 154 that controls operation of the system. The imaging system further includes an operator interface 156 that allows an operator to prescribe a scan and interact with the collected data and images. Data acquisition is controlled, via the CPU, by a data acquisition system 158. Data collected is stored in database/PACS 160. In this regard, it is contemplated that reconstructed images generated by the image processing and reconstruction subsystem 162 as well as quantitative data computed or otherwise derived from the collected data by the quantitative data analysis subsystem 164 may be stored in database 160. It is further contemplated that the database may be more than one database and remotely located from the site of data acquisition. System 152 further has one or more monitors/displays 166 to visually display images and quantitative data as set forth herein. A skilled artisan will appreciate that the imaging system may include other software, firmware, and hardware not specifically described to prescribe and execute a given scan, as well as processing the data for image reconstruction and quantitative analysis.

Additionally, it is contemplated that a dedicated workstation having a computer, monitor(s), and operably connected to the one or more databases may be used such that a physician may analyze the image and quantitative data remote from the scanner. As such, it is understood that the interactive image and quantitative data analysis tool described herein may be used remotely from the treatment facility at which the patient was scanned.

The present invention has been described with respect to a computer aided tool to facilitate efficient and effective diagnosis and assessment of abnormalities, pathologies, tumors, and the like of a medical patient based on image and quantitative data acquired with one or more medical scanners. The analysis tool not only facilitates the calculation and display of quantitative data and medical images, but also provides a comparative analysis of quantitative data and image data acquired in different scans over different periods of time. It is contemplated that images and quantitative data may be acquired with scanners of various modalities including, but not limited to, computed tomography (CT), magnetic resonance (MR), positron emission tomography (PET), ultrasound, x-ray, and nuclear medicine imaging. Moreover, the scanners used for image and quantitative data acquisition may be located at a common treatment center, such as a hospital or imaging center, or remotely located from one another. In this regard, a networked environment of scanners, image archival systems, and databases is contemplated and used to facilitate remote acquisition and storage of acquired image and quantitative data. The invention however is also applicable to stand-alone scanners such as hybrid scanners capable of acquiring image and quantitative data according to the principles of two different imaging modalities, such as hybrid PET/CT scanners. In a preferred embodiment, anatomical information and functional information is acquired with a CT scanner and a PET scanner, respectively.

The invention has been described with respect to an oncology environment wherein a PET scanner is used to acquire functional images and a CT scanner is used to acquire anatomical images to identify, evaluate, and assess treatment of cancerous lesions; however, the invention is not so limited. That is, a skilled artisan will appreciate that the present invention is applicable to other physiological studies including, but not limited to, cardiac disease and dementia, such as diagnosis, assessment, and treatment of Alzheimer's disease.

Additionally, the invention has been described with respect to an interactive tool and process, but it is understood that the invention may be embodied in a computer readable and executable code/language that is uploadable/downloadable to scanner or other workstation for implementation.

The present invention has been described in terms of the preferred embodiment, and it is recognized that equivalents, alternatives, and modifications, aside from those expressly stated, are possible and within the scope of the appending claims.

What is claimed is:

1. A computer readable storage medium having a computer program stored thereon and representing a set of instructions that when executed by a computer causes the computer to:
access a first set of data of a first data type and a second set of data of a second data type, the first set of data and the second set of data acquired from an object of interest and the first set of data acquired in a first plurality of scans and the second set of data acquired in a second plurality of scans;
derive a desired quantitative metric from the first set of data and the second set of data for the object of interest; and
display a change in value of the quantitative metric between the first plurality of scans and between the second plurality of scans.

2. The computer readable storage medium of claim 1 wherein the computer is further caused to display an image containing the first set of data and the second set of data.

3. The computer readable storage medium of claim 1 wherein the set of instructions further causes the computer to display the change in value of the quantitative metrics in one of a tabular format and a graphical format.

4. The computer readable storage medium of claim 3 wherein the first plurality of scans acquired anatomical information and the second plurality of scans acquired functional information.

5. The computer readable storage medium of claim 1 wherein the set of instructions further causes the computer to register a first image of one of the first plurality of scans with a second image of one of the second plurality of scans, and display a differential image showing differences in the first and the second images.

6. The computer readable storage medium of claim 1 wherein the set of instructions further causes the computer to compare a current value for the desired quantitative metric with a previously derived value for the quantitative metric, wherein the previously derived value is one of a baseline value or a past value derived from a previous scan.

7. The computer readable storage medium of claim 6 wherein the set of instructions further causes the computer to provide an auxiliary indication that the change in value for the desired quantitative metric is positive, neutral, or negative.

8. The computer readable storage medium of claim 7 wherein the auxiliary indication is a dedicated color.

9. The computer readable storage medium of claim 1 wherein the set of instructions further causes the computer to derive the change in the desired quantitative metric from assessment of historical data acquired over time with the first plurality and second plurality of scans.

10. The computer readable storage medium of claim 1 wherein the object of interest includes an abnormal pathology identified in one or more images reconstructed from the first set and/or the second set of data.

11. The computer readable storage medium of claim 1 wherein the first set of data includes anatomical data acquired with a first imaging modality and the second set of data includes functional data acquired with a second imaging modality.

12. The computer readable storage medium of claim 1 wherein the first set of data is acquired using CT and the second set of data is acquired using PET.

13. A medical diagnostic tool comprising:
an image database configured to contain medical images of a patient acquired over a period of time;
an analytical data database configured to contain analytical data related to the medical images; and
a graphical user interface (GUI) configured to interactively display the medical images from at least a pair of medical exams together with the analytical data related thereto and allow real-time data analysis and review of changes in the medical images acquired over the period of time.

14. The tool of claim 13 wherein the GUI displays the analytical data in one of a tabular format and a graphical format.

15. The tool of claim 13 wherein the analytical data includes a comparison between measured values of a first image and measured values of a second image acquired different in time than the first image.

16. The tool of claim 15 wherein the comparison provides a quantitative assessment of treatment effectiveness of a given pathology between acquisition of the first image and the second image, the first image and second image including at least one of anatomical information and function information of the given pathology.

17. The tool of claim 13 wherein the GUI is further configured to display a registered image generated from at least a pair of medical images, wherein the registered image highlights differences between a first medical image and a second medical image.

18. The tool of claim 17 wherein one of the first medical image and the second medical image is an atlas image of the medical patient.

19. The tool of claim 13 wherein the image database includes images acquired with medical scanners of differing modalities.

20. The tool of claim 19 wherein the differing modalities include at least two of CT, MR, PET, x-ray, ultrasound, and nuclear medicine imaging.

21. A method of presenting medical information comprising the steps of:
acquiring a history of patient medical imaging exams;
accessing at least one of quantitative anatomical data and quantitative functional data from the history of patient medical imaging exams; and
displaying at least one of the quantitative anatomical data and the quantitative functional data for at least two patient medical exams of the history of patient medical exams together with at least one fused image from the history of patient medical imaging exams to allow interactive assessment of time-elapsed changes of a patient, the fused image containing anatomical and functional information.

22. The method of claim 21 further comprising the step of generating the fused image from a first image of a first patient medical exam and a second image from a second patient medical exam, and wherein the fused image shows changes between the first and the second images.

23. The method of claim 21 further comprising the step of comparing a measured value from a first medical exam with a measured value from a second medical exam, and displaying a comparative result therefrom.

24. The method of claim 21 further comprising the step of automatically determining and showing changes in pathology characteristics from the at least two medical exams.

25. The method of claim 21 further comprising the step of selecting a pathology identifier in the display of the at least one of quantitative anatomical and quantitative functional data and automatically displaying an image of a pathology corresponding to the selected pathology identifier.

26. The method of claim 25 further comprising the step of displaying a list of computer identified and/or user identified pathologies in a single display and displaying quantitative anatomical data and quantitative functional data for the list of identified pathologies.

27. The method of claim 26 further comprising the step of automatically displaying an image of a selected pathology based on a user selection of one of the identified pathologies.

28. The method of claim 21 wherein one of the at least two medical exams is conducted prior to a given treatment and wherein another of the at least two medical exams is conducted following the given treatment.

29. The method of claim 21 wherein the steps thereof are embodied in a computer program stored on a computer readable medium for uploading of the computer program to an in-field scanner.

30. The method of claim 21 wherein the steps thereof are embodied in a computer program embodied in a computer data signal transmittable to a remote in-field scanner for downloading the computer program to the remote in-field scanner.
